(19) United States
(12) Patent Application Publication
(10) Pub. No.: US 2009/0079707 A1
(43) Pub. Date: Mar. 26, 2009

(54) INTEGRATED CAPACITIVE SENSING DEVICES AND METHODS

(75) Inventors: JOHN W. KAEHLER, LAKE BLUFF, IL (US); KEN K. FOO, GURNEE, IL (US); ZHIMING ZHUANG, KILDEER, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/859,997

(22) Filed: Sep. 24, 2007

(51) Int. Cl. G06F 3/041

(52) U.S. Cl. 345/174

(57) ABSTRACT

Disclosed are touch screen devices and methods of sensing an object near the surface of a touch screen device. A capacitive sensor is integrated into display electronics by flipping the traditional thin film transistor liquid crystal display (TFT) stack-up which has a bottom gate structure so that it is an inverted bottom gate structure. Accordingly, the gate structure is near the top of the display and the gate drive lines are re-used as excitation lines in addition to their function as display lines. The excitation lines therefore drive excitation to generate an induced electric field at the surface of the display device. Additionally, other lines are used as sensor lines so that sensor signals are input to the device controller to determine the position of an object at the surface of the display device. Accordingly, the excitation lines are scanned to detect the presence of a finger or other object.

### FIELD

Disclosed is a touch screen display device, and more particularly, integrated capacitive sensing devices and methods of an inverted bottom gate structure thin film transistor liquid crystal display to induce an electric field at the surface of the device and sense lines to detect shunted electric field lines to determine position of an object at the surface.

### BRIEF DESCRIPTION

The makers of mobile communication devices, including those of cellular telephones, are increasingly adding functionality to their devices. While there is a trend toward the inclusion of more features and improvements for current features, there is also a trend toward smaller mobile communication devices. As mobile communication device technology has continued to improve, the devices have become increasingly smaller and thinner. Fewer and/or smaller hardware and software components are therefore desirable when adding new features and making improvements to the current features in the smaller devices. Fewer hardware components may provide a cost benefit to the consumer.

Features such as touch screens can improve the user's experience, for example, in display menu manipulation and gaming on a mobile communication device as well as other types of electronic devices. Traditional touchsceens are implemented using either a resistive or capacitive sensing element on an additional layer of glass or plastic. The additional touch panel glass layer adds significant thickness, reduces brightness and can add a yellowish look to the display. Moreover, in resistive designs, spacers are usually visible as well, detracting from aesthetics of the device.

Thin design touch screens that do not use an additional layer are implemented using, for example, integrated photosensors in the thin film transistor liquid crystal display (TFT) array. Such an implementation significantly reduces the display brightness due to pixel aperture ratio reduction and requires a complicated sensing algorithm as well as restrictive color schemes. Additionally, integrated photosensors in the TFT array can only sense one touch point at a time. Other thin design touch screens include internal cell gap capacitive sensing which senses the glass movement. Again, with this implementation, there is a significant reduction in display brightness as well as a limited resolution.

### BRIEF DESCRIPTION OF THE DRAWINGS

FIG. 1 depicts one pixel of a Low Temperature Polysilicon Thin Film Transistor (LTPS TFT) display including an inverted bottom gate structure where the bottom gate structure is flipped so that the gate now faces outward;

FIG. 2 depicts a portion of a display device and an object such as a finger or a stylus;

FIG. 3 illustrates an embodiment of a portion of a TFT LCD display matrix that is adjacent the top surface of the display device where gate drivers and excitation switches are on column lines and sensing lines are alternating column lines;

FIG. 4 depicts another embodiment where the gate drivers are interleaved on alternate row lines respectively and excitation switches are on odd row lines and sensing lines are on even row lines;

FIG. 5 is a timing diagram for the display and excitation output with respect to received shunt detection; and

FIG. 6 illustrates a touch sense algorithm where the sense lines can scan in one direction, for example the x-direction, and then the other direction, the y-direction.

### DETAILED DESCRIPTION

It would be beneficial, in a thin design touch screen, in particular, to avoid a reduction in display brightness. It would be further beneficial to include fewer hardware and software components when adding new features and making improvements to the current features in the smaller and thinner devices. In particular, it is beneficial to reuse components that are already part of a device, possibly with a minimum of additional hardware or software components so that the device size and/or complexity is not substantially increased.

Disclosed are touch screen devices and methods of sensing an object near the surface of a touch screen device. As will be described in detail below, a capacitive sensor is integrated into display electronics by flipping the traditional thin film transistor liquid crystal display (TFT) stack-up which has a bottom gate structure so that as will be described in detail below, the TFT is an inverted bottom gate structure, that is, the gate faces outward. Accordingly, the gate structure is near the top of the display and the gate drive lines are re-used as excitation lines in addition to their function as display lines. The excitation lines therefore drive excitation to generate an induced electric field at the surface of the display device. Additionally, other lines are used as sensor lines so that sensor signals are input to the device controller to determine the position of an object at the surface e of the display device. Accordingly, the excitation lines are scanned to detect the presence of a finger or other object. In flipping the traditional TFT stack-up so that it is an inverted bottom gate structure, and re-using the hardware as described, the thickness of the display and therefore the device is not affected.

In general, in a display device, a plurality of column lines is configured to generate display output and a plurality of row lines is configured to generate display output. As will be described in detail below, in one embodiment at least a subset of either the column lines or row lines are configured as excitation lines, each of the subset including a driver having an excitation output. Also, at least a subset of the column lines or the row lines are sense lines that include drivers having sensor input that are coupled to sensor output lines. In this manner, the excitation source driver having an excitation output induces an electric field on or above the surface of the display device. A shunt method of sensing capacitance provides that when a finger or some other grounded object, interferes with the electric field, some of the field lines are shunted to ground and do not reach the sensor lines that act as a receiver. Therefore, the total capacitance measured at the receiver decreases when an object comes close to the induced electric field. In the described display device, display brightness is maintained and there is a simplified sensing algorithm or no requirement of restrictive color schemes. A touch screen feature can improve the user's experience, for example, in display menu manipulation and game playing on a mobile communication device as well as other types of electronic devices.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

At least some inventive functionality and inventive principles may be implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

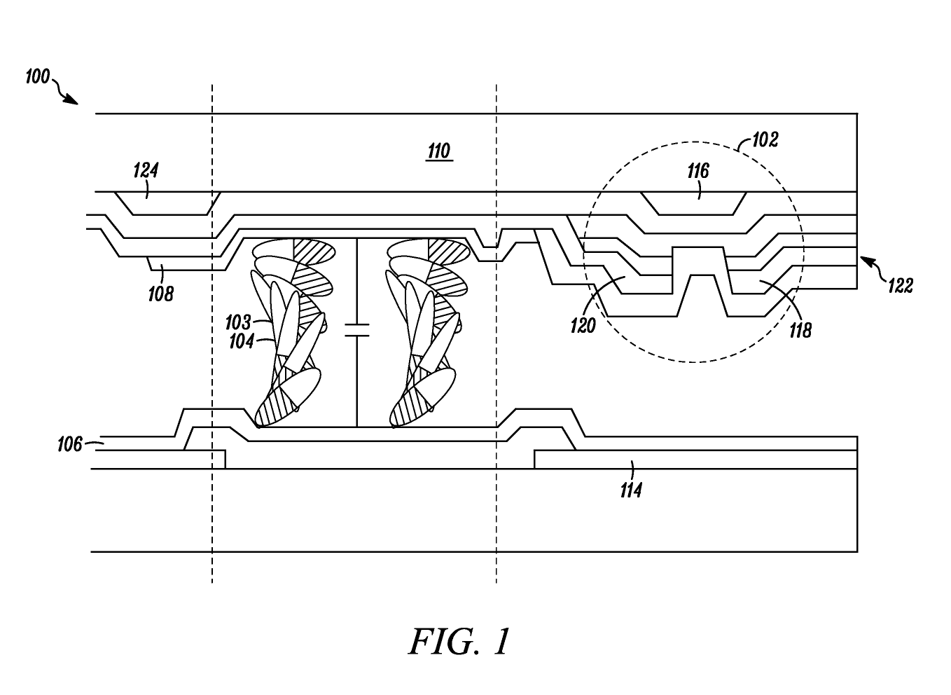

FIG. 1 depicts one pixel of a Low Temperature Polysilicon Thin Film Transistor (LTPS TFT) display 100 including an inverted bottom gate structure, that is, the bottom gate structure is flipped so that the gate now faces outward. As briefly described above, the gate structure is therefore near the top of the display and the gate drive lines that are also near the top of the display are re-used to drive excitation. Sensor signals are input to the device controller with respect to the drivers. For the excitation and the sensing for the shunt method as described above, hardware may be added to the LTPS TFT so that analog-to-digital conversions (ADC) are made, in one embodiment, on every few lines and every few columns. The ADCs might only be on every few rows, or every few columns, and maybe not both.

The capacitive sensing display structure includes a matrix of transistors, one transistor 102 of which is illustrated in FIG. 1. Light from a pixel is generated by a backlight and may pass through, for example, a twisted nematic crystal 103 across a Cholesteric Liquid Crystal (CLC) substance 104 which is coupled to the common electrode 106 and to the pixel electrode 108, with light exiting the top transparent substrate 110 which may be a piece of glass. A black matrix layer may be adjacent the transparent substrate 110. The black matrix layer maybe for example, a CrOₓ layer replacing the reflective Cr layer that is used in a bottom gate structure. In a normally black display, the black matrix layer may not be visible. A reflective layer 114 that may be for example a Cr layer, is opposite the black matrix layer. The reflective layer 114 is positioned where in a bottom gate structure replacing the black matrix that is used in a bottom gate structure. The gate 116 and its source 118 and drain 120 operate in a manner that is known in the display device art. The data bus-line or column drive line 122 and the gate drive (not shown here), and the capacitive storage capacitor 124 will be discussed in more detail below.

As will be described in more detail below, by the described re-arrangement of the bottom gate structure and modifications including possibly minimal additional hardware so that it is an inverted bottom gate structure, the column lines and the row lines of the display are substantially adjacent the transparent substrate that is the surface of the touch screen. In this way, a plurality of at least one of column lines and row lines that are configured to generate display output, include a driver providing an excitation output to generate an induced electric field adjacent the surface of the top transparent substrate 110 that is the surface of a touch screen device. Moreover, by the described inverted bottom gate structure, a plurality of at least one of row lines and column lines that are configured to generate display output, include drivers having sensor input that are coupled to sensor output lines. The sense lines are configured to sense whether there is a change in the induced electric field adjacent the surface of the touch screen device and to transmit a capacitive sensing signal via at least one sensor output line to a controller (shown below).

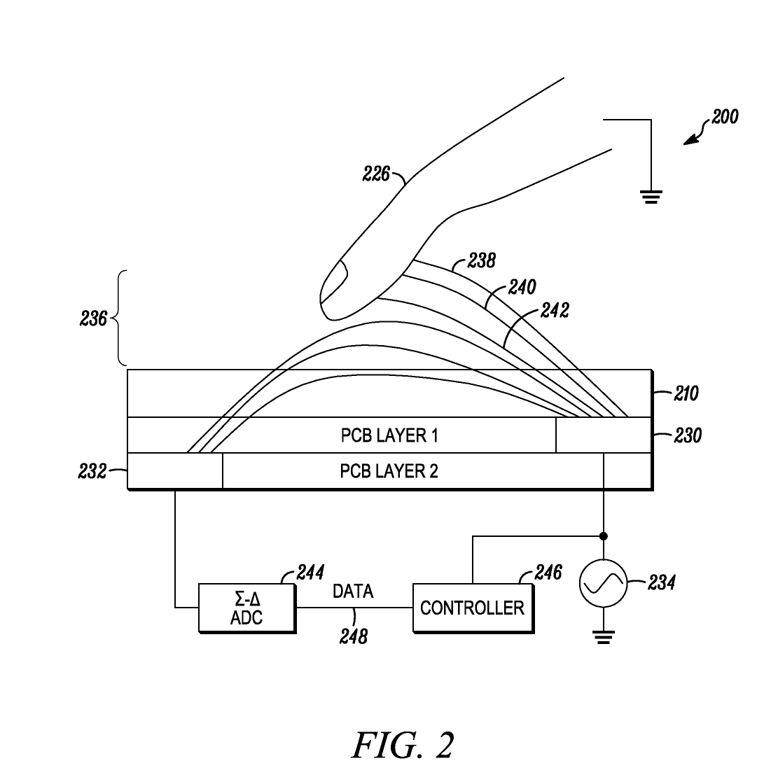

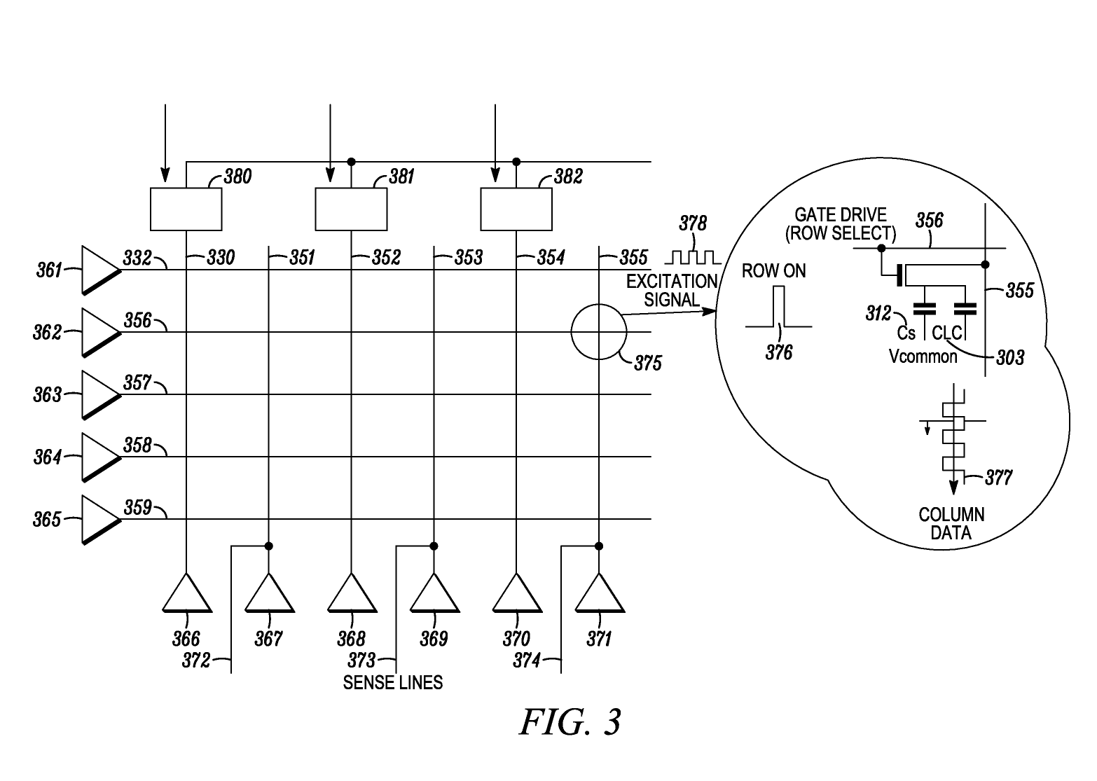

FIG. 2 depicts a portion of a display device 200 and an object 226 such as a finger or a stylus 226. The device 200 surface that may be a transparent substrate 210 is adjacent printed circuit board (PCB) layer 1 including a column line 230 for excitation and PCB layer 232 coupled to a sense line (see FIG. 3). The column line 230 includes a driver having excitation output 234 to generate an induced electric field 236 at or above the surface 210. As discussed above, a shunt method of sensing capacitance provides that when a finger or some other grounded object 226, interferes with the electric field 236, some of the field lines, in this example field lines 238, 240 and 242 are shunted to ground and do not reach the sensor lines, such as sensor line 232 that act as a receiver. Therefore, the total capacitance measured at the receiver, Sigma-delta analog-to-digital converter (Σ-δ ADC) 244 decreases when an object comes close to the induced electric field. The field lines 236 measured at the sensor line 232 are translated into a digital domain by the ADC 244. The ADC 244 is depicted as sending data to a controller 246 of the display device. The controller 246 that is in communication with the sensor output lines for example, sensor line 232, is configured to receive a capacitive sensing signal and determine where an object has come within the induced electric field. The calculations to determine position may be based on which sensor line 232 that transmits a capacitive sensing signal via its sensor output line 248 to the controller 246.

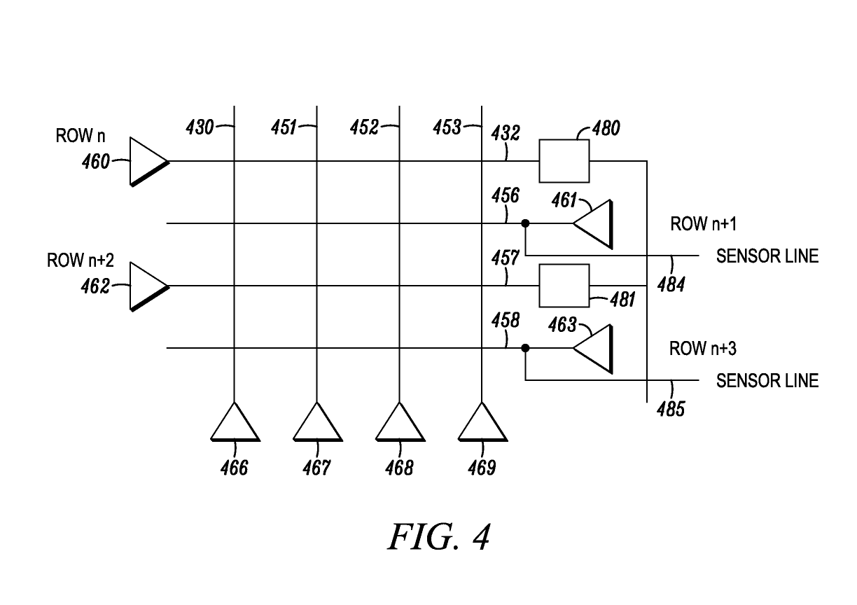

FIG. 3 illustrates a portion of a TFT LCD display matrix 350 that, as described, is adjacent the top surface of the display device. Since the otherwise bottom gate structure is flipped over to be an inverted bottom gate structure with re-arrangement and modifications including additional hardware, the column lines and the row lines are adjacent the top transparent substrate 110 (see FIG. 1) and therefore near the surface of the touch screen display device 200 (see FIG. 2). In FIG. 3, gate drivers and excitation switches are on column lines and sensing lines are on alternating column lines. The column lines 330, 352, and 354 act as excitation sources for the induced electric field, and column lines 351, 353 and 355 act as sensors with coupled sensor lines 372, 373 and 374 to determined the location of an object near the surface. It is understood that while column lines depicted in FIG. 3 act as the excitation source and as sensors, the row lines 332, 356, 357, 358 and 359 may act as both the excitation source and the sense lines (as discussed with respect to FIG. 4). Furthermore, both excitation and sensing may be accomplished by both the column lines and the row lines in any suitable arrangement. The arrangement of the described drivers and sense lines may depend, among other things, on the other components of the device and the convenience of their placement.

The rows are depicted as including gate drivers 361, 362, 363, 364, and 365, one per line. The columns are depicted as including column drive lines 366, 367, 368, 369, 370 and 371, which may be one per sub-pixel. Typically, sub-pixel data is sent in multiples of three at a time (R, G, and B). Accordingly, the matrix depicted in this FIG. 3 is not a typical use case. Sense lines 372, 373, and 374 may transmit the capacitive sensing signal data to the controller 246 (see FIG. 2) to characterize the change in the induced electric field to determine where an object is near the surface of the touch screen device based on at least one capacitive sensing signal.

At the intersection 375 of the column lines and the sense lines depicted in a blowup bubble of FIG. 3, a top structure TFT as depicted in FIG. 1 can include a storage capacitor 312 and a CLC 303 in communication with the gate drive, for example, gate drive 361, and a column drive line 355. A gate driver 361 can drive a row according, for example, to a square wave 376. A column drive line 371 can drive column data 377 that is active and inactive over time t, in particular since the display can operate as a raster scan.

An excitation signal 378 to induce the electric field including field lines 236 (see FIG. 2), may be a high frequency compared to a typical column frequency. Switches 380, 381, and 382 are depicted coupled to column lines 330, 352, and 354, respectively. The switches for processing the excitation signal 378 can be, for example, capacitive coupling, diodes, or electrically switched. The coupling of excitation may occur with the column lines 330, 352, and 354 when they are not active, and preferably provide isolation so as to not couple column data onto adjacent columns.

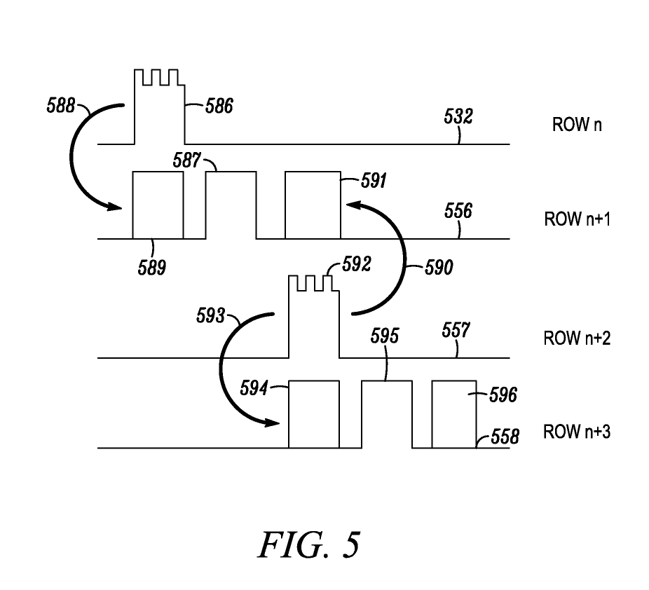

FIG. 4 depicts another embodiment where the gate drivers 460, 461, 462, and 463 are interleaved on alternative row lines 432, 456, 457 and 458 respectively and excitation switches 480 and 481 are on odd row lines and sensing lines 484 and 485 are on even row lines. Row lines 432, 456, 457 and 458 in this discussion and that of FIG. 5 are called Row n, Row n+1, Row n+2 and Row n+3 respectively. It is understood that the position of the components such as switches 480 and 481 and sense lines 372, 373 and 374 (see FIG. 3) can be in any suitable position relative to the column line and row line matrix as well in any suitable ratio. As in FIG. 3, FIG. 4 shows column lines 430, 451, 452, and 453 and column drive lines 466, 467, 468, and 469. As mentioned in reference to FIG. 3, a column drive line, such as line 466 can drive column display data 377 that is active and inactive over time t.

FIG. 5 is a timing diagram for the display and excitation output with respect to received shunt detection. FIG. 5 illustrates that Row n excites Row n+1 during Row n+1's dormant period. Row n+2 can also excite sensing Row n+1. The same is true with respect to Row n+3. The waveform 586 depicted on row line 532 include the same type of excitation signal 378 (see FIG. 3) of high frequency compared to the column frequency. The controller 246 (see FIG. 2) in communication with the row lines, in this example, is further configured to cause the row line 532 to alternatively generate a time varying induced electric field and display output. That is, when the display signal is off, the excitation signal is on. The driver 460 (see FIG. 4) in communication with the switch 480 having excitation output causes the time varying induced electric field by excitation of a small amplitude and a high frequency when the display signal is off.

Row n+1 depicts a display waveform 587 for row 556 as discussed, alternately with excitation waveform 586. The arrow 588 indicates that a shunt charge 589 is depicted under the excitation waveform 586, in this example, as occurring at the same time. As discussed above, the shunt charge 589 can occur as illustrated in FIG. 2 when a finger 226 or other object interferes with the electric field 236 and some or all of the field lines are shunted to ground and do not reach the receiver. The arrow 590 indicates that a shunt charge 591 is depicted over the excitation waveform 592 for row 557, in this example, as occurring at the same time. Similarly, the arrow 593 indicates that a shunt charge 594 is depicted under the excitation waveform 592, in this example, as occurring at the same time. On row line 558, that is Row n+3, a display waveform 595 and another shunt charge 596 are depicted. It is understood that the matrix of row and column lines can be quite extensive compared to this example. For example 20-30 rows can be covered with one finger over the described touch screen display. A sharp stylus may cover only one row.

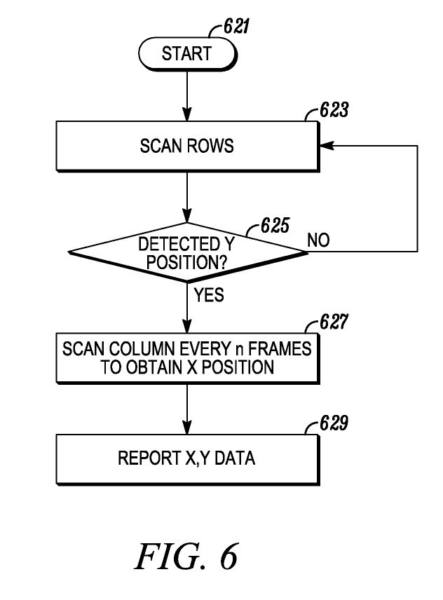

FIG. 6 illustrates a touch sense algorithm where the sense lines can scan in one direction, for example the x-direction, and then the other direction, the y-direction. Depending on the algorithm for determining the position of the object on the touch screen, a scan may need not include scanning in the x-direction. A discussed with reference to FIG. 5, to start 621, display output is generated as illustrated by waveforms 587 and 595 (see FIG. 5). An induced electric field is generated above the surface of the touch screen device 236 (see FIG. 2) at different times than when generating display output. As discussed above, the deviation in the excitation can determine the delta (delta being a mathematical label for a difference between a first value and a second value) of the received field lines from that which is generated. The sensing on the even lines, in this case Row n+1 and Row n+3 uses a column drive count to determine the x-position. Accordingly, in this example, rows are scanned 623 to detect 625 a y-direction object position. If no object is detected as having a y-direction position, the scanning 623 continues. If an object is detected as having a y-direction position, then a column scan 627 is made for some or every frame in the raster scan to obtain the x-direction object position. To avoid flicker in the display screen, a column scan 627 may be every other frame or more. The data for the x-direction and the y-direction data representing the capacitive sensing signal is transmitted 629 to the controller 246 so that it may characterize the change in the induced electric field to determine where an object is near the surface of the touch screen device based at least one capacitive sensing signal.

Since the column lines and the row lines as discussed above are adjacent the transparent substrate having as a surface, the surface of the touch screen display device, the touch screen display as described above is implemented between glass layers, and may therefore be independent of glass thickness. Since devices, in particular, mobile communication devices have become increasingly smaller and thinner, the described touch screen may be compatible with many form factors. Moreover, the described thin design touch screen, in particular, may avoid a reduction in display brightness. The described touch screen also beneficially reuses components that are already part of a device. In the above-described touch screen, flipping the bottom gate structure to be an inverted bottom gate structure possibly with a minimum of additional hardware or software components so that the device size and/or complexity is not substantially increased may provide cost benefits as well.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A touch screen device having a surface, comprising:
a plurality of at least one of column lines and row lines configured to generate display output, at least a subset of which are configured as excitation lines each of the subset including an driver having an excitation output, the subset of which are in communication with one another other to generate an induced electric field adjacent the surface of the touch screen device;
a plurality of at least one of row lines and column lines configured to generate display output, at least a subset of which being sense lines that include drivers having sensor input that are coupled to sensor output lines, the sense lines configured to sense whether there is a change in the induced electric field adjacent the surface of the touch screen device and to transmit a capacitive sensing signal via at least one sensor output line;
a controller in communication with the sensor output lines configured to receive at least one capacitive sensing signal and determine where an object has come within the induced electric field based on which of at least one sense line that includes a driver having sensor input transmits a capacitive sensing signal via its sensor output line.

2. The device as recited in claim 1, further comprising:
a transparent substrate between the surface of the touch screen device and the plurality of column lines and the plurality of row lines.

3. The device as recited in claim 2 wherein the drivers having excitation output of the subset of the plurality of column lines are substantially adjacent the transparent substrate.

4. The device as recited in claim 2, further comprising:
a black matrix layer is adjacent the transparent substrate.

5. The device as recited in claim 2, further comprising:
a reflective layer opposite the black matrix layer.

6. The device as recited in claim 1, wherein the capacitive sensing signal represents a deviation in an induced electric field adjacent the surface of the touch screen device.

7. The device as recited in claim 1 wherein the controller in communication with at least one of the column lines and the row lines is further configured to cause the at least one of the column lines and row lines to alternatively generate a time varying induced electric field and display output.

8. The device as recited in claim 7 wherein a driver having excitation output causes the time varying induced electric field by excitation of a small amplitude and a high frequency.

9. A touch screen device having a surface, comprising:
a plurality of at least one of row lines and column lines configured to output display output, at least a subset of which include an driver having excitation output and at least a subset of which include drivers having sensor input coupled to sensor output lines wherein the lines including a driver having excitation output are different from the lines including a driver having sensor input; and
a controller in communication with the sensor output lines configured to receive at least one capacitive sensing signal and determine where an object has come within the induced electric field based on which of at least one sense line that includes a driver having sensor input transmits a capacitive sensing signal via its sensor output line.

10. The device as recited in claim 9, further comprising:
a transparent substrate between the surface of the touch screen device and the plurality of row lines.

11. The device as recited in claim 10 wherein the drivers having sensor input are adjacent the transparent substrate.

12. The device as recited in claim 11, further comprising:
a black matrix layer is adjacent the transparent substrate.

13. The device as recited in claim 11, further comprising:
a reflective layer opposite the black matrix layer.

14. The device as recited in claim 9, wherein the capacitive sensing signal represents a deviation in an induced electric field adjacent the surface of the touch screen device.

15. The device as recited in claim 9 wherein driver having excitation output causes a time varying induced electric field by excitation of a small amplitude and a high frequency.

16. A method of sensing an object near the surface of a touch screen device, the method comprising:
generating display output;
generating an induced electric field above the surface of the touch screen device at different times than when generating display output;
detecting a change in the induced electric field;
generating a capacitive sensing signal representative of the change in the induced electric field;
transmitting the capacitive sensing signal to a controller; and
characterizing the change in the induced electric field to determine where an object is near the surface of the touch screen device based at least one capacitive sensing signal.

17. The method of claim 16 wherein the touch screen device has column lines and row lines, and wherein a time varying induced electric field above the surface of the touch screen device is generated by at least a subset of the column lines, the method further comprising:
alternatively driving display output of the subset of column lines and driving excitation of a small amplitude and a high frequency of the subset of column lines.

18. The method of claim 16 wherein the touch screen device has column lines and row lines, and wherein a time varying induced electric field above the surface of the touch screen device is generated by at least a subset of the row lines, the method further comprising
alternatively driving display output of the subset of row lines and driving excitation of a small amplitude and a high frequency of the subset of the row lines.

19. The method of claim 16 wherein the touch screen device has column lines and row lines, wherein detecting a change in the induced electric field further comprises:
sensing by at least one row line of the at least a subset of the row lines, a deviation in the induced electric field adjacent the surface of the touch screen device.

20. The method of claim 16 wherein the touch screen device has column lines and row lines, wherein detecting a change in the induced electric field further comprises:
sensing by at least one column line of the at least a subset of the column lines, a deviation in the induced electric field adjacent the surface of the touch screen device.
